(19) United States
(12) Patent Application Publication
(10) Pub. No.: US 2005/0060218 A1
(43) Pub. Date: Mar. 17, 2005

(54) Targeted messaging system

(75) Inventors: Michael Coutts, Dundee (GB); Simon J. Forrest, Dundee (GB); Jonathan S. Black, Dundee (GB); Martin R. Smith, Dundee (GB)

Correspondence Address: Michael Chan;NCR Corporation, WHQ-4, 1700 South Patterson Blvd., Dayton, OH, 45479-0001, US

(73) Assignee: NCR Corporation

(21) Appl. No.: 10/929,256

(22) Filed: Aug. 30, 2004

(30) Foreign Application Priority Data
Sep. 13, 2003 (GB) 0321525.8

(51) Int. Cl. G06F 17/60

(52) U.S. Cl. 705/9

(57) ABSTRACT

A method of providing immediate assistance to a user of a targeted messaging system is described. The method involves: identifying a message appropriate for presenting to the user (step 220); presenting the message to the user (step 222); offering to summon a human agent knowledgeable about products associated with the message (step 222); and summoning an agent to speak with the user in response to the user accepting the offer (step 224). The method may use a campaign server to supply the appropriate message. A self-service terminal, such as an ATM, may be used to present the message.

### BACKGROUND OF THE INVENTION

The present invention relates to a targeted messaging system. In particular, the invention relates to a customer relationship management (CRM) type of system.

CRM systems are commonly used to target messages to users of terminals. Examples of terminals include: self-service terminals (SSTs) such as automated teller machines (ATMs) and information kiosks; Web-enabled personal computers (PCs); interactive television sets; and such like.

A typical CRM system comprises a database containing information about a large number of terminal users, a plurality of terminals, and a campaign server linking the terminals and the database and supplying the terminals with targeted messages.

A campaign manager typically creates a relatively small number of messages for presenting to individuals when they use the terminals. To optimize the success of the campaign, the campaign manager typically also generates rules determining which message is presented to which group of individuals. The rules may relate to demographic groups, income groups, geographic groups, or such like. The rules are applied to the database (for example, by running queries) so that the messages to be presented are mapped to individuals. This mapping of messages to individuals is stored in tabular form in the campaign server.

When an individual uses a terminal, he/she is identified, and the identity of the user is forwarded to the campaign server. The campaign server determines from the table which message should be displayed to this user. The message is then typically personalized (for example, by inserting the user's name into the standard text) and forwarded to the terminal, which presents the personalized message to the user.

A message typically relates to a product being offered by the campaign manager, for example, a loan, an insurance policy, or such like. A message also typically includes a question asking if the user is willing to receive further information (for example, by mail or email) and/or to be contacted by telephone.

ATMs are particularly advantageous for use in CRM systems because each ATM user can be identified from the user's ATM card. Furthermore, there is typically a transaction authorization delay in each transaction that is ideal for presenting a targeted message to the user.

A disadvantage of using terminals for targeted messages is that if users request further information then there is a time delay before they receive the information because it has to be prepared, then mailed or emailed to the user. When the further information is eventually delivered, the user may have forgotten about the product and may discard the newly received information. Another disadvantage is that during this time delay, the user may go elsewhere to obtain the product.

### SUMMARY OF THE INVENTION

It is among the objects of an embodiment of the present invention to obviate or mitigate one or more of the above disadvantages or other disadvantages associated with prior art targeted messaging systems.

According to a first aspect of the present invention there is provided a method of providing immediate assistance to a user of a targeted messaging system comprising:
identifying a message appropriate for presenting to the user;
presenting the message to the user;
offering to summon an agent knowledgeable about products associated with the message; and
summoning an agent to assist the user in response to the user accepting the offer.

Preferably, the agent is a human agent who physically moves to the user to speak with them. This has the advantage that a person (the human agent) is summoned immediately to any user who requests more information about a message targeted to that user. This summoning occurs in real time, for example, before a transaction is completed at an ATM. This enables a sales prospect to be identified and quickly paired with a product specialist, thereby improving sales of that product.

The human agent may be summoned to a location and the user may be informed about that location so that the user can meet with the human agent.

Alternatively, but less preferably, the agent may be a software agent, an avatar, or such like.

If the step of summoning an agent is not successful, for example, if an agent does not respond within a predetermined time period, or if all available agents decline, then the method may include the further step of offering to send (for example, by mail or email) the user further information.

If the step of summoning an agent is not successful then the method may include the further step of offering to schedule a meeting with a human agent. The meeting may be a face-to-face meeting, a Web-based meeting, or a telephone call.

The Web-based meeting may be at a terminal in the vicinity of the user. This is particularly advantageous where the user is executing a transaction at an ATM, as it is inefficient and expensive to retain a user at an ATM for an extended time period; however, information kiosks are ideal for hosting Web-based meetings.

If the step of summoning an agent is successful, then the method may include the step of enabling recognition of the summoned agent and the user. This may be achieved by presenting the user with the agent's name and/or an image of the agent, and/or a location at which the agent can be found, for example, a concierge desk, a meeting room, or such like. If an image is provided, this image may be presented on a screen, printed out for the user to take, or both.

Enabling recognition of the summoned agent may also involve the agent receiving notification of the user's name, the location of a terminal being operated by the user, or such like. Providing both the agent and the user with recognition information increases the probability of the two parties finding each other quickly because it enables mutual recognition to occur.

The step of summoning an agent to speak with the user may include the step of accessing a table to identify:
(i) appropriate agents, and
(ii) locator information for each appropriate agent.
   The locator information for each agent may relate to an address of a portable device carried by the agent, such as an IP address; a telephone number of a portable communication device, such as a cellular telephone for receiving telephone calls or text messages; an email address; an instant message address; a pager address; or such like.

Alternatively, the step of summoning an agent to speak with the user may include the step of broadcasting over a network a request for an agent to respond to the summons. The network may be a wired or wireless network, or a combination of both.

Preferably, the method includes the further step of receiving responses from the summoned agents, determining whether a received response indicates that the agent is available or not, and pairing an agent with the user. The agent selected for pairing may be the first available agent, the agent having experience in the type of product being targeted at the user, or a combination of both.

It will now be appreciated that this aspect of the present invention has the advantage that a product specialist can be summoned in real time to speak to a prospective customer immediately after the customer indicates that he/she has an interest in a product, thereby improving the likelihood of the product specialist selling the product.

According to a second aspect of the present invention there is provided a targeted messaging system for providing immediate assistance to a user, the system comprising:
identifying means for identifying a message appropriate for presenting to the user;
presenting means for presenting the message to the user and for offering to summon an agent knowledgeable about products associated with the message; and
summoning means for summoning an agent to assist the user in response to the user accepting the offer to summon an agent.

Preferably, the identifying means comprises a campaign server.

Preferably, the presenting means comprises a terminal having a display for presenting the message in visual form. Alternatively, the presenting means comprises a terminal having a loudspeaker for presenting the message in audible form. Presenting means directed to other senses may also be used, such as tactile and olfactory senses.

Preferably, the presenting means presents text on the display in the form of a question, and/or by playing a sound file in which a person asks a question.

The campaign server may serve a plurality of terminals.

Preferably, the summoning means comprises a controller and a network over which the controller sends a message. The network may be an IP network, a cellular telephone network, a proprietary (non-IP) network, or such like.

Preferably, the summoning means includes storage space for storing details of agents and their contact details. The storage space may also store availability details for each agent.

The storage space may be implemented by a file stored in memory, on disk storage space, or such like. The file may take the form of a look-up table, or any other convenient form.

According to a third aspect of the present invention there is provided a terminal for use in a targeted messaging system, the terminal comprising:
a user identification device for identifying a user of the terminal;
a network connection for transmitting the user's identity to a campaign server and for receiving a message therefrom for presenting to the user;
a user interface for presenting the received message to the user and offering the user an immediate meeting with an agent; and
a controller for summoning an appropriate agent in response to a positive user response to the offer of an immediate meeting.

The user identification device may comprise a card reader, such as a magnetic stripe card reader, an integrated circuit card reader, or a hybrid card reader. The user identification device may comprise a wireless tag reader, such as an RFID reader, an i-button reader, or such like. Alternatively, the user identification device may comprise a biometric recognition unit for capturing and analyzing a trait or characteristic of the user. Suitable biometric units may include a human iris biometric device, a voice biometric device, a fingerprint biometric device, a hand geometry biometric device, a facial recognition biometric device, and such like.

The network connection may be implemented by an ethernet card, a modem, a wireless communication card, or such like.

The user interface may be in the form of a display and/or a loudspeaker for presenting visual and/or audible messages to the user.

The controller may be implemented by a processor and associated main memory for executing (i.) a terminal application controlling the operation of the terminal, (ii.) an operating system, and (iii.) a client object for receiving messages and making the received messages available to the terminal.

The terminal may be a self-service terminal such as an information kiosk or an ATM.

In embodiments where an ATM is used, the user is an ATM customer, and the controller preferably summons an appropriate agent prior to completion of the transaction being executed by the customer.

Where an ATM is used in a branch environment, a remote campaign server may be used, and a local assistance program may be executed in a computer in the branch to provide contact details for agents, so that the controller summons an agent after referring to the local assistance program. The local assistance program may include an availability schedule for each agent.

According to a fourth aspect of the present invention there is provided a bank branch system comprising: at least one self-service terminal, and at least one notification device coupled to the at least one self-service terminal; the terminal comprising:
user identifying means for identifying a user of the terminal;
communicating means for transmitting the user's identity to a campaign server and for receiving a message therefrom for presenting to the user;
presenting means for presenting the received message to the user and offering the user an immediate meeting with an agent; and
a controller for summoning an appropriate agent in response to a positive user response to the offer by sending a request to a notification device used by the appropriate agent.

This aspect of the invention has the advantage that an ATM is coupled to the branch communication systems so that the ATM can send messages to product specialists working within the branch, thereby furnishing the product specialists with prospective sales opportunities.

The controller may include a local assistance program to enable the controller to identify one or more agents who may be available to help the customer. Alternatively, the controller may broadcast a summons to all agents within the vicinity of the branch.

According to a fifth aspect of the present invention there is provided a method of assisting a user of a targeted messaging system, comprising:
receiving on a device a summons from the targeted messaging system requesting a meeting with the user;
responding via the device to the summons; and
receiving a summons confirmation in the event that the response accepted the meeting.

The method may include the further step of meeting with the user to assist the user.

The step of receiving a summons may include the sub-step of receiving the summons via a wireless connection.

### BRIEF DESCRIPTION OF THE DRAWING

These and other aspects of the present invention will be apparent from the following specific description, given by way of example, with reference to the accompanying drawings, in which:

FIG. 1 is a simplified plan view of a banking facility including terminals used in a targeted messaging system;

FIG. 2 is a schematic view of the electronic hardware architecture of the system of FIG. 1;

FIG. 3 is a simplified schematic view of an ATM installed in the facility of FIG. 1;

FIG. 4 is a flow diagram illustrating steps involved in a transaction executed at the ATM of FIG. 3;

FIG. 5 is a pictorial view of part of the ATM of FIG. 3, showing the ATM display;

FIG. 6 is a table illustrating a staff list accessed by the ATM of FIG. 3; and

FIG. 7 is a schematic diagram of a portable device carried by a staff member in the facility of FIG. 1 and in communication with the system of FIG. 2.

### DETAILED DESCRIPTION

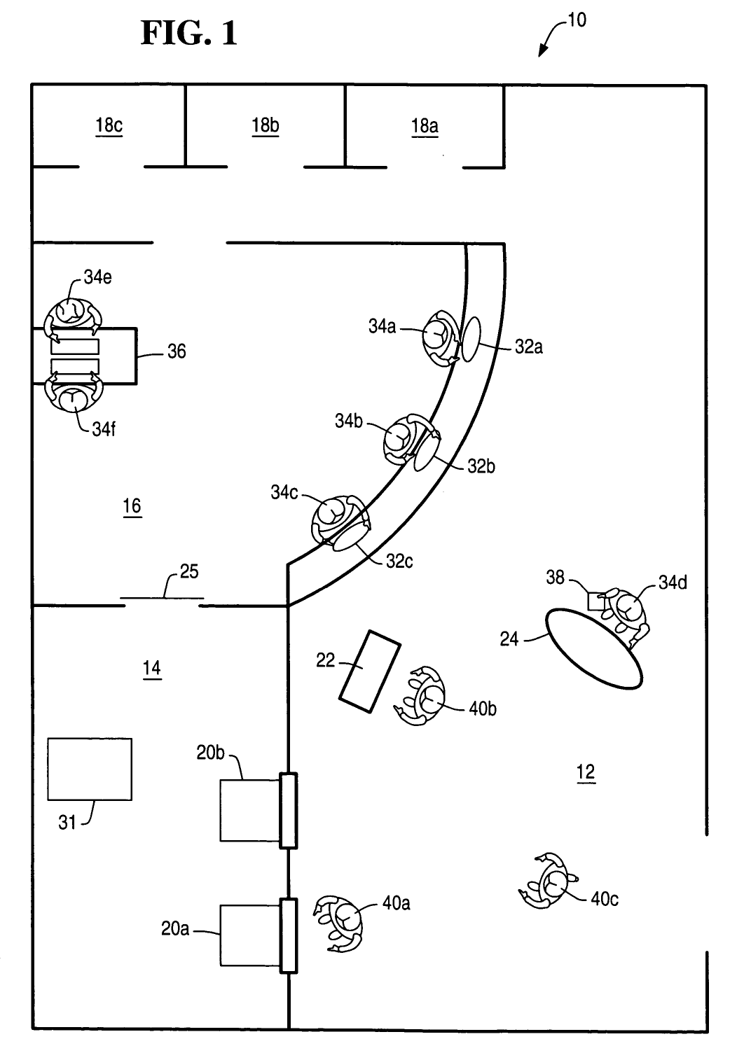

Reference is now made to FIG. 1, which shows a facility 10 in the form of a bank branch. The bank branch 10 has an entrance foyer 12, a secure back-office area 14, a counter area 16, and three customer meeting rooms 18.

The entrance foyer 12 includes: two through-the-wall ATMs 20a,20b for the use of bank customers wishing to perform self-service transactions; an information kiosk 22 freestanding in the foyer 12 for use by a bank customer wishing to obtain more information about a financial product such as a loan or insurance policy; and a concierge station 24 for assisting customers.

The secure back-office area 14 is located behind a security door 25 and houses rear portions of the ATMs 20.

The counter area 16 includes three workstations 32 at which bank staff 34 login and which bank staff 34 use to execute teller assisted transactions on behalf of customers. The counter area 16 also has a computerized desk area 36 to the rear of the counter area 16 at which members of the bank staff 34 perform administrative tasks and other functions.

In FIG. 1, three members of the bank staff 34a,b,c are working at the three workstations 32a,b,c, one member of the bank staff 34d is at the concierge station 24 to assist customers, and two members of the bank staff 34e,f are working at desk area computers 36.

The staff member 34d at the concierge station 24 is carrying a portable digital assistant (PDA) 38 owned by the banking facility 10.

In FIG. 1, three customers 40 are inside the banking facility 10. One customer 40a is at the first ATM 20a, another customer 40b is using the kiosk 22, the third customer 40c has just entered the facility 10 and is walking towards the second ATM 20b.

Hardware Architecture

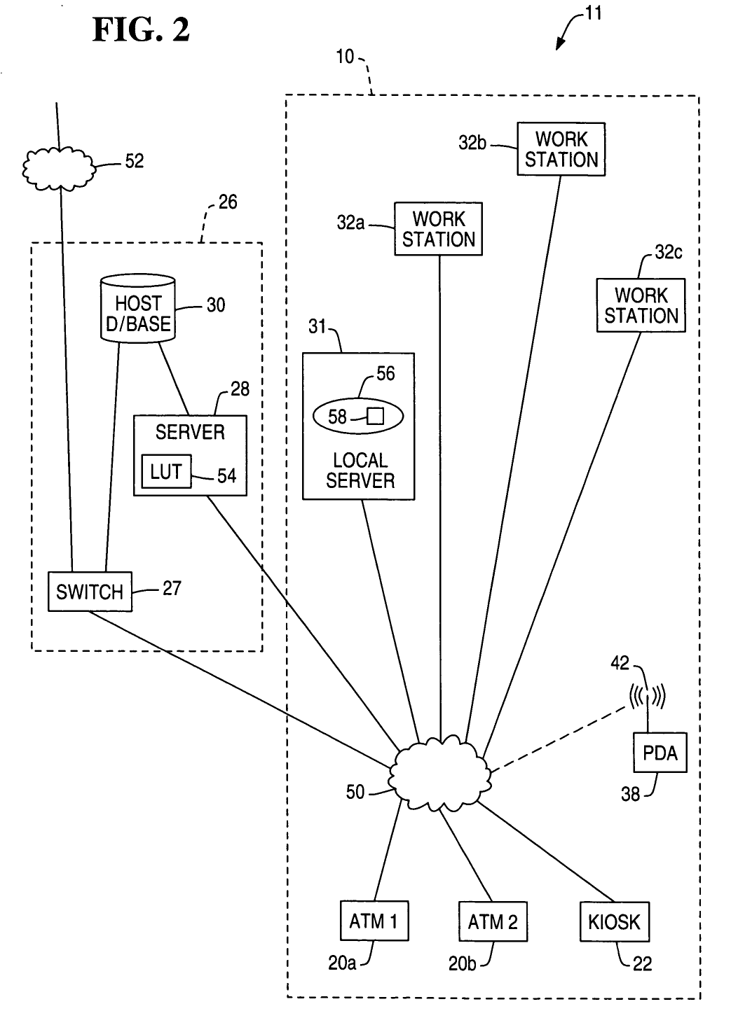

Reference is now made to FIG. 2, which shows the electronic system architecture 11 of is the banking facility 10 and a remote transaction processing and storage centre 26.

The transaction centre 26 comprises: a transaction switch 27 for routing transactions to an appropriate authorization authority, a campaign server 28, and a host database 30 for storing personal and financial information relating to customers of the banking facility.

An IP network 50 interconnects the various computing devices in the branch 10 and the remote storage centre 26. This IP network 50 allows the ATMs 20 to access: the transaction switch 27; the campaign Web server 28; and a local server 31 located within the branch 10.

The transaction switch 27 is coupled to the host database 30 for authorizing transactions for customers of the facility 10 and of other facilities (not shown) and other ATM clusters (not shown). The switch 27 is also coupled to interchange networks 52 external to the facility 10 for routing transactions for customers from other banks and from other card issuers.

When an ATM customer inserts a card, the Web server 28 provides the ATM with an appropriate message for presenting to that customer. To achieve this, the Web server 28 stores a lookup table 54 mapping ATM card data to campaign messages. Such campaign Web servers are well known in the art, and one suitable campaign Web server 28 is available from Broadvision (trade mark) Inc., 585 Broadway, Redwood City, Calif. 94063.

The local server 31 includes: a staff availability program 56 storing a list 58 comprising name, availability, and contact information for members of staff. The staff availability list 58 is updated by the Web-based program 56, which is accessible to members of staff 34 from one of the workstations 32, computers 36, and the PDA 38.

The Web-based program 56 presents each staff member 34 with a personal diary, which that staff member 34 can use to enter times when he/she is unavailable for assisting ATM customers 40, as will be described in more detail below.

IP network 50 is the facility Intranet and is used to link the ATMs 20 and workstations 32 to the switch 27. The kiosk 22 and the PDA 38 are also coupled to the IP network 50, but for security reasons they have no access to the switch 27 or host database 30. The PDA 38 communicates with the IP network 50 via wireless communications transmitted and received from an antenna 42. The PDA 38 may be any convenient networked personal organizer device, such as a Palm (trade mark) Tungsten (trade mark) W device.

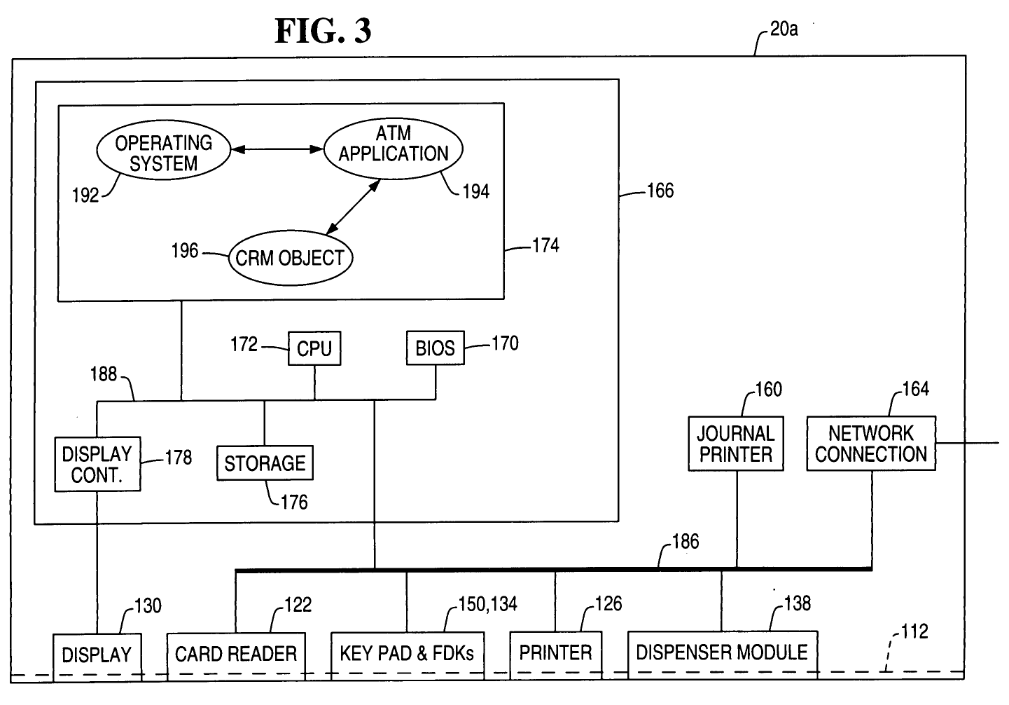

Reference is now made to FIG. 3, which shows one of the ATMs 20a in more detail. ATM 20a comprises a fascia, illustrated schematically by line 112. The fascia 112 provides a user interface to allow a user to interact with the ATM 20a. In particular, the fascia 112 has apertures aligning with modules mounted in an ATM chassis (not shown). The fascia 112 defines: a card reader slot (not shown) aligning with a card reader module 122; a receipt printer slot (not shown) aligning with a receipt printer module 126; a display aperture (not shown) aligning with a display 130 and associated function display keys (FDKs) 134 mounted as a module; and a dispenser slot (not shown) aligning with a dispenser module 138. The fascia 112 also includes an encrypting keypad 150.

The ATM 20a includes: a journal printer module 160 for creating a record of every transaction executed by the ATM 20a; a network connection module 164 for accessing the transaction switch 27; and a controller module 166 (in the form of a PC core) for controlling the operation of the ATM 20a, including the operation of the modules.

The controller module 166 comprises a BIOS 170 stored in non-volatile memory, a microprocessor 172, associated main memory 174, storage space 176 in the form of a magnetic disk drive, and a display controller 178 in the form of a graphics card.

The display module 130 is connected to the controller module 166 via the graphics card 178 installed in the controller module 166. The other ATM modules (122, 126, 134, 138, 142, and 150) are connected to the ATM controller module 166 via a device bus 186 and one or more internal controller buses 188.

In use, the main memory 174 is loaded with an ATM operating system kernel 192, an ATM application 194, and a CRM client object 196. As is well known in the art, the operating system kernel 192 is responsible for memory, process, task, and disk management. The ATM application 194 is responsible for controlling the operation of the ATM 20a. In particular, the ATM application 194: (i.) provides the sequence of screens used in each transaction (referred to as the transaction flow); (ii.) monitors the condition of each module within the ATM (state of health monitoring); and (iii.) obtains authorization for transactions via the switch 27.

The term “screen” is used herein to denote the graphics, text, controls (such as menu options), and such like, that are presented on an SST display; the term “screen” as used herein does not refer to the hardware (that is, the display) that presents the graphics, text, controls, and such like. Typically, when a transaction is being entered at an SST, a series of screens are presented in succession on the SST display, the next screen displayed being dependent on a user entry or activity relating to the current screen. For example, a first screen may request a user to insert a card; once a card has been inserted a second screen may invite the user to enter his/her PIN; once the final digit of the PIN has been entered, a third screen may invite the user to select a transaction; and so on.

The CRM client object 196 receives messages from the CRM Web server 28 and presents these messages to the ATM application 194, which decides whether to present these messages to an ATM customer via the display 130.

Transaction Example

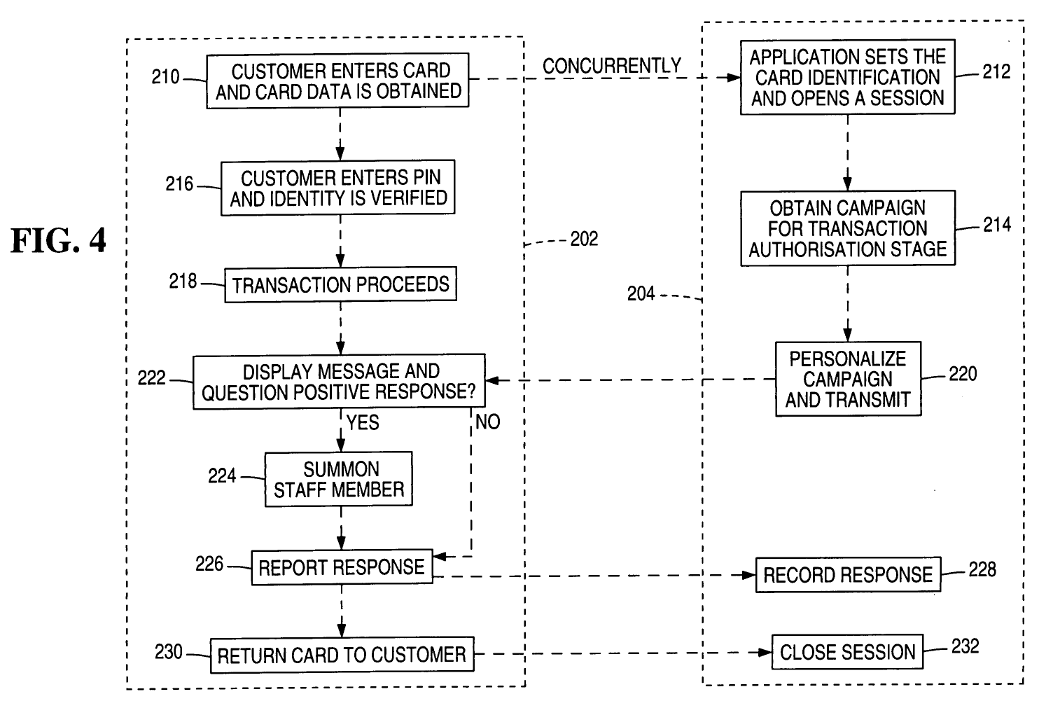

A typical transaction at the ATM 20a will now be described with reference to FIGS. 1 to 3, and also with reference to FIG. 4, which illustrates steps implemented during a transaction at the ATM 20a by both (i.) the ATM application 194 (illustrated by area 202 on the left side of FIG. 4) and (ii.) the client object 196 and campaign Web server 28 (illustrated by area 204 on the right side of FIG. 4).

Initially, the ATM customer 40a is uniquely identified by insertion of his/her ATM card into the ATM (step 210), which causes a start session message to be sent from the CRM client object 196 to the Web server 28. This causes the Web server 28 to initiate a session for that ATM customer 40a (step 212).

The Web server 28 then identifies whether any campaign information is available for presenting to that customer 40a (step 214) by accessing the lookup table 54 using the ATM card number as the primary key.

The transaction flow at the ATM (that is, the sequence of screens presented to the user) continues simultaneously with the operation of the client object 196 and Web server 28, so that a sequence of screens is presented to the ATM customer 40a at the same time that the Web server 28 retrieves a message for presenting to the customer 40a.

Once the customer's PIN is entered (step 216), the ATM 20a allows the customer to proceed through various transactional steps (step 218) in the same manner as in a conventional ATM. Typically the first of these steps is selection of the required transaction, for example, withdrawal of cash or a statement or some other financial service. Once the user selects a particular service this sets in motion a series of steps that have to be carried out by the ATM 20a and by the switch 27. In a typical ATM transaction, a time-delay is associated with one of these steps. For example, in a cash withdrawal transaction, the user is typically asked to enter the required amount, then a message is sent from the ATM 20a to the switch 27 including: the requested amount, the ATM card details, and an encrypted PIN offset. This message requests authorization for dispensing that amount of cash from the bank account identified by the ATM card details.

If a message is available for presenting to the customer 40a, that is, if there is a message corresponding to the customer's ATM card number, then the Web server 28 personalizes the message by inserting the customer's first name, which was obtained from the lookup table 54, and forwards the message to the CRM client object 196 (step 220).

The CRM client object 196 informs the ATM application 194 that it has received a message for the customer 40a, and exposes the message to the ATM application 194 in a pre-defined format, which takes the form of properties.

When a request for authorization signal is generated by the ATM 20a, the ATM application 194 renders the received personalized message into a format suitable for display on the ATM and causes the ATM 20a to present the campaign message (step 222) during the transaction authorization stage.

In this example, the customer is called John, the standard campaign text is “you have been pre-approved for a low interest loan”, so the personalized campaign message is “John, you have been pre-approved for a low interest loan”.

The ATM 20a also displays a question that asks the customer 40a if he would like to speak to a product specialist about the product being offered, which in this example is a low interest loan.

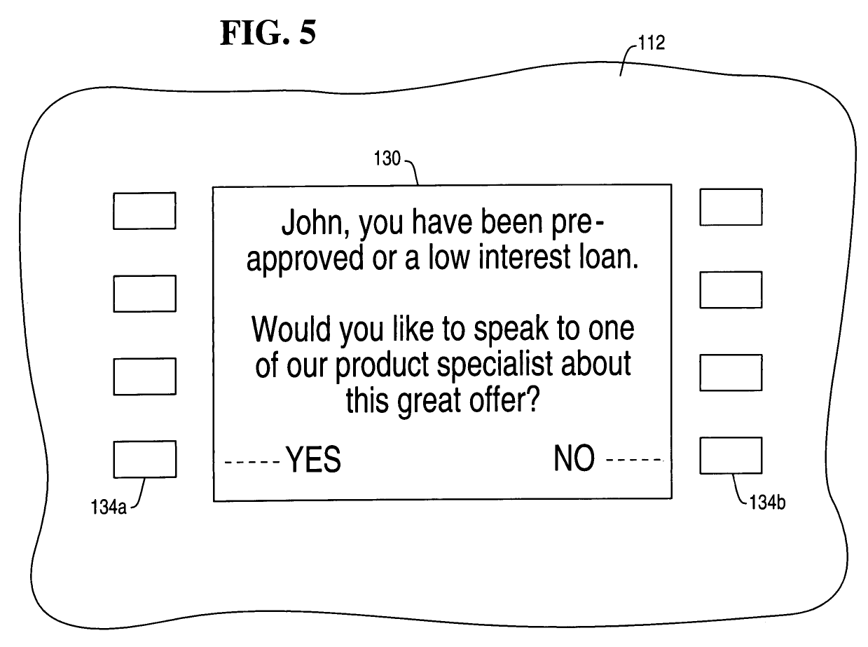

FIG. 5 is a pictorial view showing part of the fascia 112 and illustrating how the message and question may be presented on the ATM's display 130.

If the customer 40a does not wish to speak to a product specialist, then the customer 40a presses the FDK 134b aligned with the “NO” option. If the customer 40a does not make a selection within a pre-determined amount of time, for example, six seconds, then the ATM 20a determines that the customer 40a does not wish to speak to the product specialist. For both of these events, the ATM 20a proceeds to step 226. However, if the customer 40a does wish to speak with a product specialist, then the customer 40a presses the FDK 134a aligned with the “YES” option.

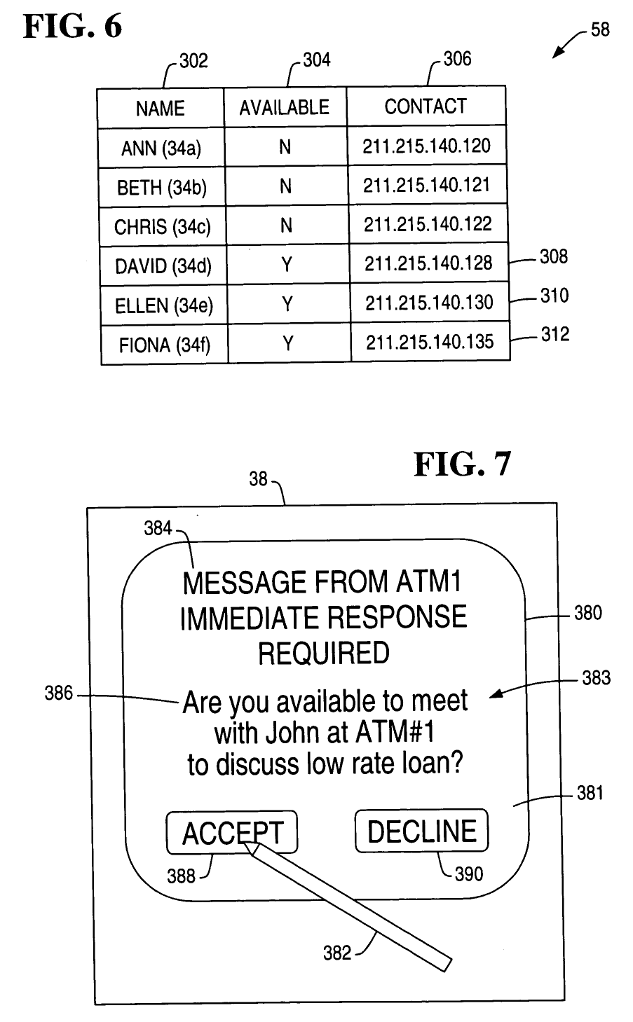

If the customer 40a requested to speak to a product specialist then the ATM application 194 transmits a summons to one or more appropriate staff members 34 (step 224). This is achieved by the ATM application 194 interrogating the staff availability list 58, which is shown in detail in FIG. 6, to determine which members of staff may be available.

The list 58 comprises three columns, a name column 302 storing the staff member's name; an availability column 304 indicating whether the staff member is available (a “Y” entry) or unavailable (an “N” entry); and a contact information column 306 indicating, in this example, an IP address at which the member of staff can be reached.

In this example, there are six members of staff on the list 58. Ann (34a in FIG. 1) is at workstation 32a serving customers, so is not available; Beth 34b is also at a workstation 32b so is not available; likewise, Chris 34c is at a workstation 32c and is unavailable. However, David 34d is at the concierge desk, and Ellen 34e and Fiona 34f are at the back-office desk, and they are all available. Each of these staff members 34 updated his/her entry using the Web-based program 56.

The ATM application 194 determines from the list 58 that David (row 308), Ellen (row 310), and Fiona (row 312) are all potentially available, and transmits a message to the IP address for each of these three staff members (from column 306) to summon them to the ATM 20a.

An example of how this message appears on the PDA 38 is shown in FIG. 7, which is a pictorial view of the PDA 38. The message format as presented on a PC or workstation is very similar to that which is presented on the PDA 38.

The PDA 38 has a touch-sensitive panel 380 co-extensive with and overlapping a PDA display 381 to allow the PDA user to select options using a stylus 382. The message 383 has a header 384 indicating which ATM sent the message and that the message requires an immediate response. The message 383 also has body text 386 stating that a user named John is at ATM#1 20a and would like to discuss a low interest rate loan. The message 383 requests the staff member to respond immediately by selecting either an “accept” option 388 or a “decline” option 390 presented on the PDA display 381.

Ellen 34e receives the summons 383 at the computer desk 36 but is currently speaking to a customer on the telephone so declines the summons. David 34d receives the summons 383 as a message on the PDA 38, and is not currently speaking to a customer, so he accepts the summons. Fiona 34f receives the summons 383 at the computer desk 36 and also accepts the summons.

The ATM application 194 receives the acceptance from David 34d before it receives the acceptance from Fiona 34f so it responds to Fiona 34f canceling the summons and responds to David confirming the summons. The confirmation may include John's full name.

The ATM application 194 then presents a screen to John 40a informing him that a staff member called David will come and speak to John 40a shortly, once John 40a has completed the transaction at the ATM 20a.

If no staff member responds to the summons 383 within a pre-set time period (in this embodiment twelve seconds), or if all staff member responses decline the summons, then the ATM application 194 presents John 40a with a screen stating that no staff members could be found, and inviting John to speak to a member of staff when they become available. Alternatively, the ATM application 194 may ask John if he would like to schedule a meeting or a telephone conversation with a member of staff at some future time. If John 40a accepts, then the ATM application 194 sends a message to one of the bank staff members providing him or her with John's name and account number, and asking him or her to contact John to schedule a meeting.

At a convenient point before the end of the transaction, or after the transaction, the customer's response (if any) to the original offer of providing a staff member to speak with the customer is forwarded by the ATM 20a to the Web server 28 (step 226), and stored in the lookup table 54 (step 228) for future use in determining what messages are to be presented to that customer 40a.

The ATM 20a then dispenses the requested cash, returns the ATM card to the customer 40a and notifies the Web server 28 that the customer's card has been returned (step 230).

The Web server closes the customer session (step 232) in response to the ATM notification in step 230.

David 34d receives the confirmation message from the ATM application 194 and walks over to speak to John 40a. Once John 40a receives his cash and his card from the ATM 20a, David introduces himself to John, and they both walk to a meeting room 18a to discuss loan possibilities.

The confirmation message from the ATM application 194 may include, or provide a Web link to, further customer information from the host database 30 or the Web server 28. An example of such further information is an event that triggered the campaign message being assigned to John 40a, such as a recent deposit of a large sum of money into John's bank account. Another example may be previous targeted messages that John 40a had not expressed an interest in pursuing. Yet another example may be details of John's account. This information may help prepare David 34d for his meeting with John 40a. David 34d can also use the PDA 38 to invite a branch supervisor or manager to join the meeting, for example to approve different terms or conditions for a product being offered to John 40a.

The ATM 20a uses its journal printer 160 to record all summons confirmation messages sent, so that a branch manager can determine which staff members met with customers, thereby enabling the manager to determine which staff members are best at converting sales prospects into actual sales. The manager may use this information to update the staff availability list 58 so that only those members of staff who are proficient at converting sales prospects into sales are kept on the list 58.

Various modifications may be made to the above described embodiments within the scope of the present invention. For example, in other embodiments, the ATMs may be coupled to the transaction switch by a proprietary, non-IP, network. In such an embodiment, the ATMs may include another network connection to communicate with devices carried and/or used by members of staff. The other network connection may be implemented by a wireless network card for use with an IP network, a dial-up modem, a paging device, or such like.

In other embodiments, each member of staff may carry a personal computing device, such as a PDA or cellular telephone to receive summon messages from the ATMs. Such summon messages may be delivered using any convenient wireless transmission such as: Bluetooth (trade mark), WiFi, IrDA, or such like. SMS text messaging may even be used, but this is not desirable because there may be delays in receiving a text message because it is transmitted via a store and forward switch. Delays are undesirable because the system attempts to pair a customer with a member of staff in real time, and some transactions, such as ATM transactions, typically end within 60 seconds of the start of the transaction.

In other embodiments, the ATM 20a may inform a customer that he/she can use the kiosk 22 to access more information about a financial product, such as the product described in the message. The kiosk may be used for a Web-based meeting with a product specialist; this is particularly useful if there is no product specialist on-site or in the vicinity of the ATM.

In other embodiments, the ATM may present a customer with an image of the member of staff who will speak to the customer. Images of staff members may be stored in the ATM 20, in the Web server 28, in the local server 31, or in any other convenient location for access via the Intranet 50.

In other embodiments, the functionality of the local server 31 may be incorporated into another computing device. For example, one of the workstations 32 may include the staff availability program 56 and list 58.

In other embodiments, the ATM 20 may broadcast a summons to every staff member and confirm the first acceptance received. This would be easier to implement, but it has the disadvantage that staff members who are busy with customers receive unwanted messages.

In other embodiments, the facility may not be a banking facility, but may be another facility which uses self-service terminals, for example, a post office, a government office, or such like.

In other embodiments, the ATM may include a loudspeaker and/or a headphone set to provide a customer with audio information. This enables a multi-media message to be delivered to the customer.

In other embodiments, the campaign message presented to the customer may be longer and/or less formal than the example given, for example, a message may be “You appear to have some spare savings, would you like to discuss transferring these to a high interest yielding account?”. The campaign message may comprise a series of messages.

In some embodiments, only certain members of staff would be included in the list 58, such as those who are trained to sell particular products.

In other embodiments, the list 58 could be more complex, so that different employees are listed for different types of products. Thus, the ATM application 194 would attempt to find a staff member who is available and knowledgeable about the product being offered in the campaign message. This could be achieved by mapping staff training records to the different products offered in various campaign messages. If no suitably knowledgeable staff member was available, another staff member may be summoned to assist the customer. The list may have multiple fields for staff expertise, so that a member of staff may have an entry including all the different products he/she can advise on, together with an indication of his/her proficiency. For example, Ann may have high level proficiency in mortgages, medium level proficiency in loans, and low level proficiency in investments; Beth may have high level proficiency in investments, low level proficiency in loans, and low level proficiency in mortgages. If Ann and Beth both accept a summons message for a mortgage enquiry, then the system may accept (send a confirmation to) Ann rather than Beth, because Ann is more proficient than Beth at advising on mortgages.

In other embodiments, the staff availability list may be maintained by a call centre, and the call centre staff may be alerted when an ATM customer requests a product specialist to assist him or her. The call centre staff may alert a member of staff based on the information stored in the staff availability list.

In other embodiments an alert program may be executed on each computer, workstation, and PDA, and the user may have to login to that device (computer, workstation, or PDA) so that the alert program is aware of what staff member, if any, is using the device. This may enable the alert program to indicate that the staff member is at that location. This may also enable the alert program to respond to summon requests automatically if the staff member is conducting a transaction for a customer at that device. Alternatively, each workstation may update the diary for the staff member using that workstation; for example, when a workstation is in “teller” mode the workstation may update the diary for the staff member using that workstation.

In some embodiments, if the customer declined the offer to meet with a human agent, then the CRM system may default to a conventional operating mode, that is, the CRM system may mail out information to the customer. Alternatively, the CRM system may provide a software agent or an Avatar for use by the customer.

In some embodiments, the system may prepare members of staff by informing them that they may be required to assist a customer prior to the offer of a meeting being made to the customer. This may occur when a targeted message for the customer has been identified.

In other embodiments, the targeted message may not be personalized.

The summons message presented to staff members may be different to that shown in the above embodiment. For example, the customer's full name may be provided to each staff member instead of just the customer's first name. Alternatively, the confirmation may include the customer's full name but the summons message may not include any name or only the first name of the customer.

1. A method of providing immediate assistance to a user of a targeted messaging system, the method comprising:
identifying a message appropriate for presenting to the user;
presenting the message to the user;
offering to summon an agent knowledgeable about products associated with the message; and
summoning an agent to assist the user in response to the user accepting the offer.

2. A method according to claim 1, further comprising offering to send the user follow up information when summoning an agent is unsuccessful.

3. A method according to claim 1, further comprising offering to schedule a meeting with an agent when summoning an agent is unsuccessful.

4. A method according to claim 1, further comprising enabling recognition of the summoned agent and the user.

5. A method according to claim 1, wherein summoning an agent to speak with the user includes accessing a table to identify (i) appropriate agents, and (ii) locator information for each appropriate agent.

6. A method according to claim 1, further comprising receiving responses from the summoned agents, determining whether a received response indicates that the agent is available or unavailable, and pairing the first available agent with the user.

7. A targeted messaging system for providing immediate assistance to a user, the system comprising:
identifying means for identifying a message appropriate for presenting to the user;
presenting means for presenting the message to the user and for offering to summon an agent knowledgeable about products associated with the message; and
summoning means for summoning an agent to assist the user in response to the user accepting the offer to summon an agent.

8. A system according to claim 7, further comprising means for offering to send the user follow up information when summoning an agent is unsuccessful.

9. A system according to claim 7, further comprising means for offering to schedule a meeting with an agent when summoning an agent is unsuccessful.

10. A system according to claim 7, further comprising means for enabling recognition of the summoned agent and the user.

11. A system according to claim 7, wherein the summoning means includes means for accessing a table to identify appropriate agents and locator information for each appropriate agent.

12. A system according to claim 7, further comprising means for receiving responses from the summoned agents, means for determining whether a received response indicates that the agent is available or unavailable, and means for pairing the first available agent with the user.

13. A terminal for use in a targeted messaging system, the terminal comprising:
a user identification device for identifying a user of the terminal;
a network connection for transmitting the user's identity to a campaign server and for receiving a message therefrom for presenting to the user;
a user interface for presenting the received message to the user and offering the user an immediate meeting with an agent; and
a controller for summoning an appropriate agent in response to a positive user response to the offer of an immediate meeting.

14. A bank branch system comprising:
at least one notification device; and
at least one self-service terminal coupled to the at least one notification device, the at least one self-service terminal including (i) user identifying means for identifying a user of the terminal, (ii) communicating means for transmitting the user's identity to a campaign server and for receiving a message therefrom for presenting to the user, (iii) presenting means for presenting the received message to the user and for offering the user an immediate meeting with an agent, and (iv) a controller for summoning an agent in response to a positive user response to the offer by sending a request to the at least one notification device.

15. A method of assisting a user of a targeted messaging system, the method comprising:
receiving on a device a summons from the targeted messaging system requesting a meeting with the user;
responding via the device to the summons; and
receiving a summons confirmation when the response accepts the meeting.
